(19) United States
(12) Patent Application Publication
(10) Pub. No.: US 2011/0264813 A1
(43) Pub. Date: Oct. 27, 2011

(54) METHOD AND SYSTEM FOR MANAGING COMMUNICATION SESSION ESTABLISHMENT

(76) Inventors: Brijesh Kumar Nair, Bangalore (IN); Mayuresh Madhukar Patil, Bangalore (IN); Saurabh Ravindra Bejkar, Bangalore (IN); Sung-Jin Park, Gyeonggi-do (KR)

(21) Appl. No.: 13/120,129

(22) PCT Filed: Sep. 18, 2009
(86) PCT No.: PCT/KR09/05335

§ 371 Date: Jun. 13, 2011

(30) Foreign Application Priority Data
Sep. 19, 2008 (IN) 2295/CHE/2008

(51) Int. Cl. G06F 15/16

(52) U.S. Cl. 709/228

(57) ABSTRACT

A method and system for managing communication session establishment is provided. The method includes receiving a request from a first communication device to establish communication session with one or more communication devices. The method then receives a plurality of media type parameters associated with communication session establishment based on Session Description Protocol (SDP). The method further sends the plurality of media type parameters to the one or more communication devices. Further, the method receives media capabilities information of each communication device based on SDP. The media capabilities information includes at least one of information associated with types of media each communication device is capable of receiving and information about types of media each communication device is incapable of receiving. The method then establishes communication session between the first communication device and each of the one or more communication device based on the capabilities of each of the communication devices.

### TECHNICAL FIELD

The present invention relates to managing communication session in a communication network. More particularly, the present invention relates to managing communication session establishment.

### BACKGROUND ART

Over a period of time, technology associated with communication networks has evolved significantly. Today, one communication device is capable of communicating with one or more communication device at a same time. A communication device using IP Multimedia Subsystem (IMS) based application can send audio, video and/or text data to plurality of communication devices based on capabilities of the plurality of communication devices. For example, in server based IMS applications like Push to talk over Cellular (PoC) and Instant Messaging (IM) that uses Session Initiation Protocol (SIP) along with SDP for allowing one communication device to establish communication session with one or more communication device at the same time.

A server in the IMS based application for providing communication uses media negotiation mechanism based on common agreed media between communication devices. Hence when a user, for example a user A sends a session invitation with audio and video capabilities, the server forwards the invitations with audio and video media parameters to other users, for example one or more terminating users. Further depending on terminating user responses, a common media is selected for a session. Hence, only audio session is established if any one of the one or more terminating users selects only audio.

### DISCLOSURE OF INVENTION

### Technical Problem

However this common media negotiation procedure could be a limitation in a scenario where there are users with diverse media capabilities, for example when a user downgrades an ongoing session. This can be explained with reference to the following example. Consider an ongoing audio-video group session among first user, second user and third user. Hence, when third user moves to a low bandwidth area, and decides to downgrade the session to only audio. The third user sends a re-INVITE message to the server with the downgraded media parameters. The server, in turn, updates the complete group session to audio. Therefore the first user and the second user also have to necessarily change the session to the audio media.

In another scenario, the media negotiation procedures can be limiting when a new user joins a group communication session. Therefore any user trying to join an ongoing group communication session has to join with the already negotiated media parameters of the ongoing session.

Hence there exists a need to efficiently manage communication session establishment.

### Technical Solution

In an embodiment, a method for managing communication session establishment is provided. The method includes receiving a request from a first communication device to establish communication session with one or more communication devices. The method also includes receiving a plurality of media type parameters associated with communication session establishment based on Session Description Protocol (SDP) from the first communication device. Further, the method sends the plurality of media type parameters associated with the communication session establishment to the one or more communication devices. The method then receives media capabilities information of each communication device from the one or more communication device based on Session Description Protocol. The media capabilities information includes at least one of information associated with types of media the each communication device is capable of receiving and information about types of media the each communication device is incapable of receiving. Thereafter, the method establishes communication session between the first communication device and each of the one or more communication devices based on the type of media the each communication device is capable of receiving, wherein the type of media is identified from the media capabilities information.

In another embodiment, a method for managing communication session establishment is provided. The method includes receiving a request to establish a communication session. The method also includes receiving one or more media type parameters along with the requests. The media type parameters include information about type of media that is required for establishing communication. The method then identifies media capabilities of the communication device. The method moreover sends an indication to block one or more type of media data during communication. Further, the method establishes a communication session based on the indication and the one or more media type parameters.

In yet another embodiment, a server is provided. The server includes a transceiver configured to receive a request from a first communication device to establish communication session with one or more communication devices. The transceiver also receives a plurality of media parameters associated with communication session establishment based on Session Description Protocol (SDP). Further, the transceiver sends the plurality of media type parameters associated with the communication session establishment to the one or more communication devices. The transceiver then receives media capabilities information from each communication device from the one or more communication device based on Session Description Protocol, wherein the media capabilities information includes at least one of an information about types of media the each communication device is able to receive and an information about types of media the each communication device is unable to receive. The server also includes a processor configured to establish communication session between the first communication device and each of the one or more communication device based on the media capabilities information received from each of the one or more communication devices.

In still another embodiment, a communication device is provided. The communication device includes a transceiver configured to receive a request to establish a communication session. The transceiver also receives one or more media type parameters along with the requests, wherein the media type parameters includes information about type of media that is required for communication. The transceiver sends an indication to block one or more type of media data during communication. The communication device also includes a processor configured to identify media capabilities of the communication device. The processor also establishes a communication session based on the indication and one or more media type parameters.

### Advantageous Effects

Various embodiments of the present invention described above provide the following advantages. The present invention provides a method for managing communication session establishment. The method allows a communication device to establish SIP based communication session with a plurality of communication devices based on media capabilities of the plurality communication devices. Hence, the communication device can communicate with different communication devices using different media data at the same time.

Hence, the method allows a communication device from a plurality of communication devices to blocks a particular media type data without effecting communication session of the plurality of communication devices. The method also allows a communication device to store and/or forward a particular media type data to another communication device when the communication device is not able to or incapable of receiving the particular media type data while continuing a communication session.

### BRIEF DESCRIPTION OF DRAWINGS

FIG. 1 illustrates an exemplary environment where various embodiments of the present invention can be practiced;

FIG. 2 illustrates a server in accordance with one embodiment of the present invention;

FIG. 3 illustrates a communication device in accordance with one embodiment of the present invention;

FIG. 4 illustrates a flow chart depicting a method of managing communication session establishment in accordance with one embodiment of the present invention;

FIG. 5 illustrates a flow chart depicting a method of managing communication session establishment in accordance with another embodiment of the present invention;

FIG. 6 illustrates a flow diagram depicting a method of managing communication session establishment in accordance with one embodiment of the present invention; and

FIG. 7 illustrates a flow diagram depicting a method of managing communication session establishment in accordance with another embodiment of the present invention.

### BEST MODE FOR CARRYING OUT THE INVENTION

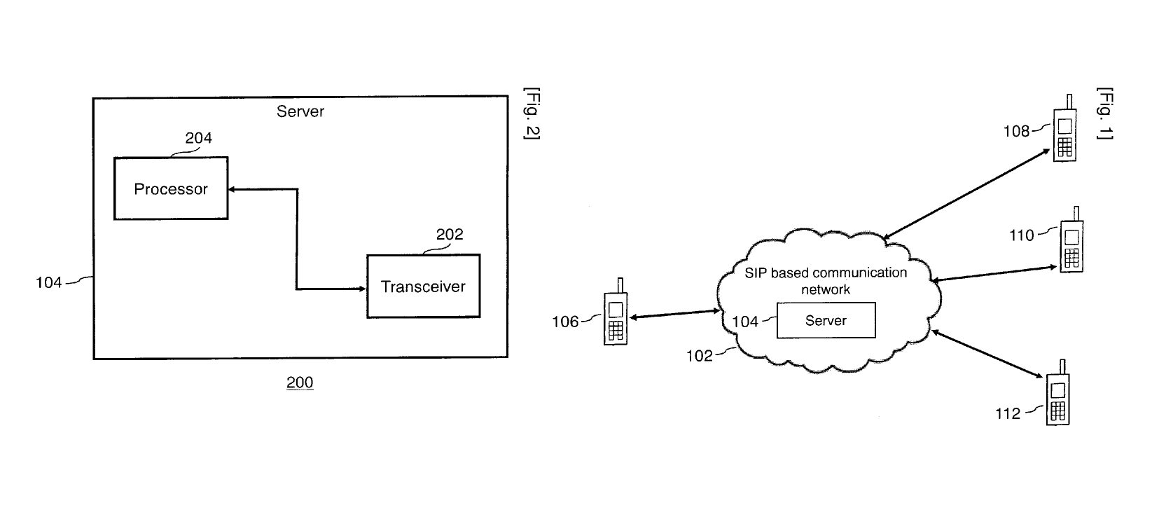

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are no where intended to represent a chronological order, as and where stated otherwise. A set is defined as a non-empty set including at least one element.

FIG. 1 illustrates an exemplary environment 100 where various embodiments of the present invention can be practiced. The environment 100 includes a communication network, a server, a plurality of communication devices associated with the server. For example, the environment 100 includes a communication network 102 that is associated with a server 104. In an example, the communication network 102 establishes communication session based on Session Initiation Protocols (SIP). The communication network 102 establishes a communication session between a communication device, for example the communication device 106 and one or more communication devices, for example, a communication device 108, a communication device 110 and a communication device 112.

The communication device 106 initially request the server 104 in the communication network 102 to establish a SIP based communication session with the communication device 108, the communication device 110, and the communication device 112 along with the media type parameters. In an embodiment, the media type parameters are the type of media data that will be sent by the communication device 106 during communication.

The communication devices 108, 110 and 112 will then send a response that will include their corresponding media capabilities to the server 104. For example, the communication device 108 will send audio, video and text if the communication device 108 is capable of receiving audio, video and text data. Similarly, the communication device 110 will send audio and text. Further, the communication device 112 will send only text. Hence, the server 104 will establish a SIP communication between the communication devices based on the media capabilities of each communication device. For example, the server 104 establishes communication session between the communication device 106 and the communication device 108 using audio, video and text media data. Similarly, the server 104 establishes communication session between the communication device 106 and the communication device 110 using audio and text media data. Further, the server 104 establishes communication session between the communication device 106 and the communication device 110 using text media data at the same time.

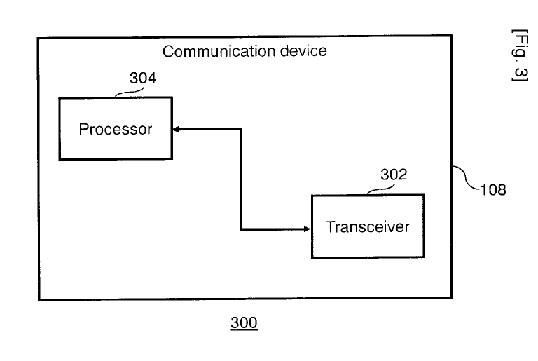

FIG. 2 illustrates a server in accordance with one embodiment of the present invention. To explain the server, references will be made to FIG. 1. However, it will be apparent to a person ordinarily skilled in the art that the present embodiment can be explained with the help of any other suitable embodiment of the present invention. The server 104 in the communication network 102 includes a transceiver 202 and a processor 204.

The transceiver 202 is configured to receive a request from a first communication device to establish communication session with one or more communication devices. For example, the server 104 in the communication network 102 receives a request from the communication device 106 to establish a communication based on Session Initiation Protocol (SIP) with the communication device 108, the communication device 110 and the communication device 112.

The transceiver 202 also receives a plurality of media parameters associated with communication session establishment based on Session Description Protocol (SDP). The plurality of media parameters include, but are not limited to, type of media data, port number, protocol type, profiles and attributes. The transceiver 202 then sends the plurality of media parameters associated with the communication session establishment to the one or more communication devices. Hence, the transceiver 202 will receive plurality of media parameters from the communication device 106 and sends the plurality of media parameters to the communication device 108, the communication device 110, and the communication device 112.

Thereafter, the transceiver 202 receives media capabilities information from each communication device from the one or more communication device based on Session Description Protocol. In an embodiment, the media capabilities information includes information about types of media the each communication device is able to receive and/or information about types of media the each communication device is unable to receive. Hence, the transceiver 202 receives media capabilities of the communication device 108, the communication device 110, and the communication device 112. For example, the transceiver 202 will receive only audio data capability from the communication device 108 if the communication device 108 is capable of handling only audio data. Similarly, the transceiver 202 will receive only audio data and video data capabilities from the communication device 110 if the communication device 110 is capable of handling both audio data and video data.

The processor 204 then establishes communication session between the first communication device and each of the one or more communication device based on the media capabilities information received from each of the one or more communication devices. Hence, the processor 204 will establish a communication session between the communication device 106 and the communication device 108 using audio. Further, at the same time the processor 204 will establish a communication session between the communication device 106 and the communication device 110 using audio data and video.

FIG. 3 illustrates a communication device 108, in accordance with one embodiment of the present invention. To explain the communication device, references will be made to FIG. 1. However, it will be apparent to a person ordinarily skilled in the art that the present embodiment can be explained with the help of any other suitable embodiment of the present invention. The communication device 108 includes a transceiver 302 and a processor 304.

The transceiver 302 in the communication device 108 receives a request to establish a communication session. In an embodiment, the request is received from the server 104. In an embodiment, the server 104 receives the request from the communication device 106. The transceiver 302 then receives one or more media type parameters along with the requests. In an embodiment, the media type parameters include information about type of media that is required for communication.

Thereafter, the processor 304 identifies media capabilities of the communication device, for example, the communication device 108. The transceiver 302 then sends an indication to block one or more type of media data during communication based on the media capabilities of the communication device 108. For example, the transceiver 302 will send an indication to block video data if the communication device 108 is incapable of or unable to receive video media data. Thereafter, the processor 304 establishes a communication session based on the indication and one or more media type parameters.

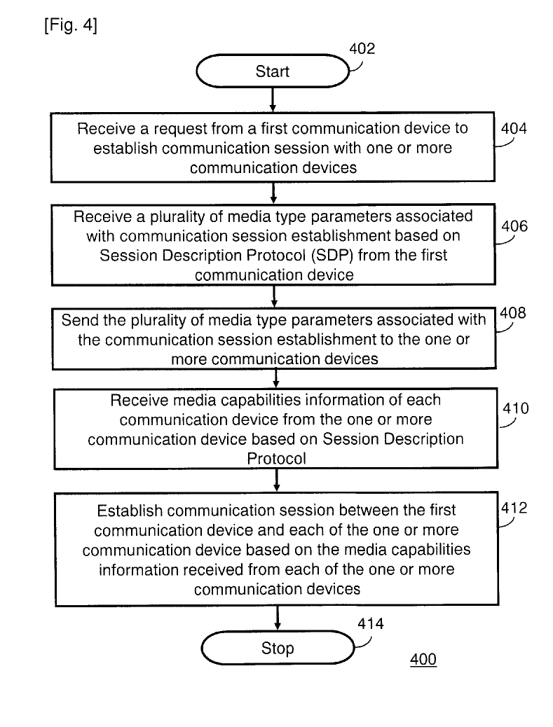

FIG. 4 illustrates a flow chart depicting a method 400 of managing communication session establishment in accordance with one embodiment of the present invention. To explain the method 400, references will be made to FIG. 1. However, it will be apparent to a person ordinarily skilled in the art that the present embodiment can be explained with the help of any other suitable embodiment of the present invention. The method 400 can also include more or fewer number of steps as depicted in FIG. 4. Further, the order of the steps may also vary. In an embodiment, the method is performed at the server.

At step 402 the method 400 is initiated. At step 404, the method 400 receives a request from a first communication device to establish communication session with one or more communication devices. In the environment 100, the server 104 in the communication network 102 receives a request from the communication device 106 to establish SIP based communication session with the communication device 108, the communication device 110 and the communication device 112.

At step 406, the method also receives a plurality of media type parameters associated with communication session establishment based on Session Description Protocol (SDP) from the first communication device. Hence, the plurality of media type parameters is received based on SDP from the communication device 106. Exemplary media type parameters and attributes are as follows.

...
c=IN IP4 107.108.72.237
m=audio 3456 RTP/AVP 97
a=rtpmap:97 AMR
...
m=video 8800 RTP/AVP 34
a=rtpmap:34 H263
...

In the first statement ‘c=IN IP4 107.108.72.237’, parameters include connection request, for example ‘c’ with type of protocol, for example ‘IP4’ along with the IP address ‘107.108.72.237’. Hence the command is interpreted as the connection offer using the defined protocol and the IP address. Further, the statement ‘m=audio 3456 RTP/AVP 97’ specifies type of media ‘m’ data is ‘audio’ along with port number ‘3456’ along with protocol and the A/V profile ‘RTP/AVP 97’. The next statement mentions type of codec ‘AMR’ for the above profile. Similarly, the statement ‘m=video 8800 RTP/AVP 34’ mentions media type ‘Video’ with port number ‘8800’ along with protocol and profile as ‘RTP/AVP 34’. Further, the statement ‘a=rtpmap: 34 H263’ mentions about the attributes. The above mentioned attributes are with reference to the communication standard RFC 2327. In an embodiment, the above mentioned attributes is based on SDP body format.

At step 408, the method 400 then sends the plurality of media type parameters associated with the communication session establishment to the one or more communication devices. Hence, the parameters, for example the media parameters mentioned in above example are sent to the communication device 108, the communication device 110 and the communication device 112. In an embodiment, the one or more communication device then identifies their individual media capabilities and thereby sends the identified media capabilities to the server in the communication network.

At step 410 the method receives media capabilities information of each communication device from the one or more communication device based on Session Description Protocol (SDP). In an embodiment, the media capabilities information includes at least one of information associated with types of media the each communication device is capable of receiving and information about types of media the each communication device is incapable of receiving. For example, the server 104 receives information about audio capabilities of the communication device 108, when the communication device 108 supports only audio type data.

Similarly, the server 104 receives information about audio and video capabilities of the communication device 110, when the communication device 110 supports both audio and video type data. In an example, the response from the one or more communication device is shown as follows.

....
c=IN IP4 107.108.87.234
m=audio 8346 RTP/AVP 97
a=rtpmap:97 AMR
...
m=video 9800 RTP/AVP 34
a=sliced
....

In the above example, the communication device, for example the communication device 108 is capable of receiving only audio data and incapable of receiving video data. Therefore the communication device 108 can send a ‘Sliced’ attribute associated with the video data. Hence, the server 104 can identify that the communication device 108 is incapable of handling the type of media data (video data) when a ‘Sliced’ attribute is received associated with the type of media data. In an embodiment, the ‘Sliced identifier is sent based on the SDP protocol. Similarly, the communication device 110 will not send a sliced identifier as the communication device 110 is capable of handling both audio and video data.

At step 412, the method establishes communication session between the first communication device and each of the one or more communication device based on the type of media the each communication device is capable of receiving. In an embodiment, the type of media is identified from the media capabilities information. In an embodiment, the method blocks the type of media data that is associated with the sliced identifier. In another embodiment, the method forwards a type of media data to a third communication device based on a response received from one or more communication devices and the media capabilities of each of the one or more communication devices.

In an embodiment, the method can also forward a type of media data that is associated with the sliced identifier to a third communication device. For example, the communication device 108 that is incapable of handling video type data can forward the video data to another device. In an embodiment, the communication device 108 can forward the video type data using the following steps.

.....
m=video 9800 RTP/AVP 34
a=sliced; connect=<device-tag>
....

In the above steps, the communication device can send a response to the server 104 by associating ‘sliced’ identifier with video media type parameter and mentioning a device to which the video data has to be forwarded. In an embodiment, the method establishes communication session between the first communication device and each of the one or more communication devices by blocking a type of media during communication between the first communication device and a second communication device from the one or more communication device when the second communication device is unable to receive the type of media or incapable of receiving the type of media.

Further, the method 400 establishes a communication session based on the media capabilities of the second communication device. In an embodiment, the media capabilities of the second communication device include information about the type of media data that the second communication device is capable of receiving. At step 414, the method is terminated.

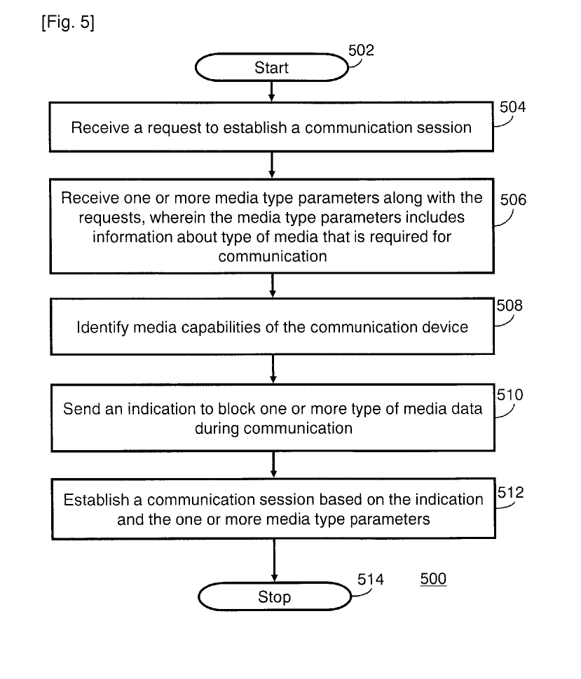

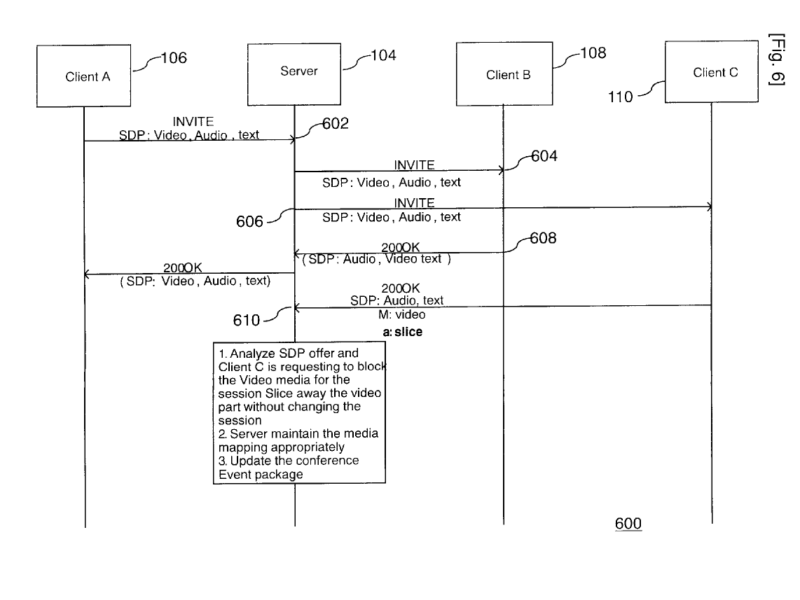

FIG. 5 illustrates a flow chart depicting a method 500 of managing communication session establishment in accordance with another embodiment of the present invention. To explain the method 500, references will be made to FIG. 1. However, it will be apparent to a person ordinarily skilled in the art that the present embodiment can be explained with the help of any other suitable embodiment of the present invention. The method 500 can also include more or fewer number of steps as depicted in FIG. 5. Further, the order of the steps may also vary. In an embodiment, the method is performed by the server.

At step 502 the method 500 is initiated. In an embodiment, the method 500 is performed at the communication device 108. At step 504, the method 500 receives a request to establish a communication session. In an embodiment, the request is received from the server 104. Further, the server 104 receives the request from the communication device 106. At step 506, the communication device 108 then receives one or more media type parameters along with the requests. In an embodiment, the media type parameters include information about type of media that is required for establishing communication. For example, the communication device will receive media type as audio and video if both audio and video is required for establishing a communication session. Examples of media type parameters are shown as follows.

....
c=IN IP4 107.108.72.237
m=audio 3456 RTP/AVP 97
a=rtpmap:97 AMR
...
m=video 8800 RTP/AVP 34
a=rtpmap:34 H263
...

At step 508 the method identifies media capabilities of the communication device, for example, the communication device 108. For example, the method identifies that the communication device 108 is capable of receiving only audio data and incapable of receiving video data. Further, at step 510, the method sends an indication to block one or more type of media data during communication. In an embodiment, the indication includes information about the type of media data that is blocked along with a sliced identifier. In an example, the indication can be sent as follows.

....
c=IN IP4 107.108.87.234
m=audio 8346 RTP/AVP 97
a=rtpmap:97 AMR
...
m=video 9800 RTP/AVP 34
a=sliced
....

At step 512, the method 500 establishes a communication session based on the indication and the one or more media type parameters. For example, the method establishes communication session between the communication device 106 and the communication device 108 using only the audio type data and blocking the video type data. In an embodiment, the video type data is forwarded to a third communication device while maintaining communication session between the communication device and a second communication device using the one or more type of data based on the media capabilities. At step 514, the method is terminated.

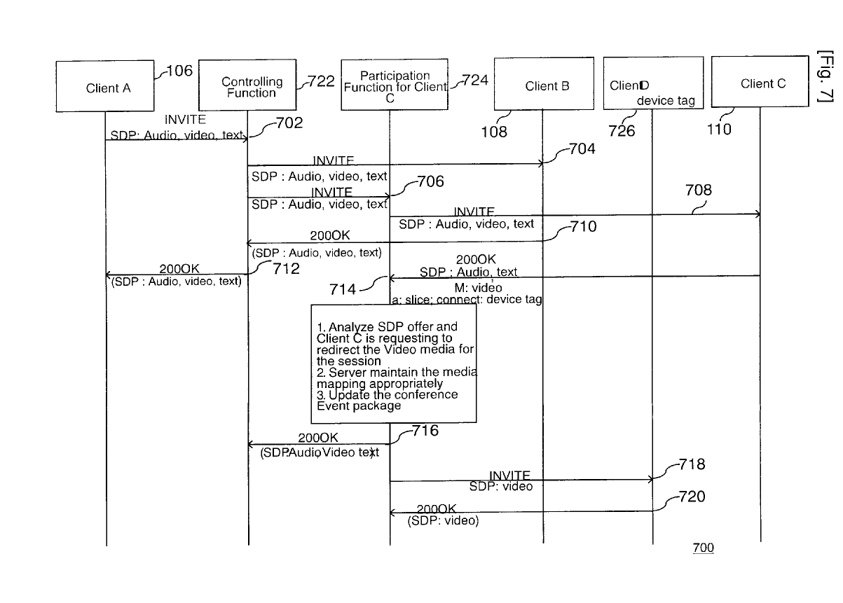

FIG. 6 illustrates a flow diagram depicting a method 600 of managing communication session establishment in accordance with one embodiment of the present invention. To explain the method 600, references will be made to FIG. 1. However, it will be apparent to a person ordinarily skilled in the art that the present embodiment can be explained with the help of any other suitable embodiment of the present invention.

At step 602, the client A, for example the communication device 106 sends a request to a server, for example the server 104, for establishing communication session with one or more communication device. In an embodiment, the communication device 106 sends a request to the server for establishing communication session with Client B (the communication device 108) and Client C (the communication device 110). The request is sent using INVITE message along with media type parameters, for example audio/video/text. In an embodiment, the request is sent based on SDP protocol.

At step 604, the server 104 sends an INVITE message along with the media type parameters to the Client B, for example the communication device 108. At step 606, the server 104 sends an INVITE message using along with media type parameters to the Client C, for example the communication device 110. At step 608, the Client B sends a response to the server. The Client B sends the response along with its corresponding media capabilities. For example, the Client B will respond to the server through a 200 OK message along with Audio, Video and Text parameters, if the Client B is capable of receiving Audio, Video and Text data.

At step 610, the Client C (for example the communication device 110) sends a response to the server along with the media capabilities of the Client C. Hence, the Client C will reply using 200OK message along with Audio, Text and will associate a ‘Sliced’ identifier with Video media type, if the Client C is not capable of receiving ‘Video’ data from the Audio, Video and Text data. In an embodiment, the response from the Client B and Client C is sent based on SDP.

Thereafter, the server 104 analyses the SDP offer from the Client C and Client B. The server 104 then identifies that the Client C is requesting to block the video media data and want to continue the session with only audio and text media data. The server also identifies that the Client B is capable of receiving all the media type data (Audio/Video/Text). Hence, the server establishes Session Initiation Protocol (SIP) based communication session between the Client A and Client B using Audio, Video and Text media data.

Further, the server at the same time establishes Session Initiation Protocol (SIP) based communication session between the Client A and Client C using Audio and Text media data. In an embodiment, when a request from a communication device is received in between the communication session then the server manages the media mapping and updates the conference event package accordingly.

FIG. 7 illustrates a flow diagram depicting a method 700 of managing communication session establishment in accordance with one embodiment of the present invention. To explain the method 700, references will be made to FIG. 1. However, it will be apparent to a person ordinarily skilled in the art that the present embodiment can be explained with the help of any other suitable embodiment of the present invention.

At step 702 Client A, for example the communication device 106 sends an INVITE message along with media types, for example audio, video and text to a controlling function 722 for establishing communication session with Client B and Client C. At step 704, the controlling function 722 sends an INVITE message to the Client B along with media types. At step 706, the controlling function 722 sends an INVITE message along with media types to a Participating function for Client C 724. At step 708, the Participating function for Client C 724 will send an INVITE message to the Client C.

At step 710, the Client B 108 will send a response along with media capabilities to the controlling function 722. Hence, the Client B 108 sends 200OK message along with audio, video and text to the controlling function 722. At step 712, the method forwards the response of Client B to the Client A. At step 714, the Participating function for Client C 724 will receive a response from the Client C. Hence, the Participating function for Client C 724 receives 200OK message along with audio and text as media capabilities and a ‘Sliced’ attribute for video media data. The response also includes a ‘device-tag’ for forwarding the video media data to a particular device during communication.

At step 716, the Participating function for Client C 724 sends information about device-tag and the media capabilities of the Client C to the controlling function 722. At step 718, the Participating function for Client C 724 sends an INVITE message to a Client D (a device associated with the device-tag) along with video type. At step 720, the Client D sends a response a 200OK message, to the Participating function for Client C 724. Hence, when the communication session will be established between the Client A 106 and Client B 108 and Client C 110, the Client B 108 will receive all the type of media (audio, video and text) form the Client A 106. Further, the Client C 110 will receive only audio and text media data and the video media data will be forwarded to the Client D 726.

Although the present disclosure has been described with an exemplary embodiment, various changes and modifications may be suggested to one skilled in the art. It is intended that the present disclosure encompass such changes and modifications as fall within the scope of the appended claims.

1-15. (canceled)

16. A method for managing communication session establishment, the method comprising:
receiving a request from a first communication device to establish a communication session with one or more communication devices;
receiving a plurality of media type parameters associated with communication session establishment based on Session Description Protocol (SDP) from the first communication device;
sending the plurality of media type parameters associated with the communication session establishment to the one or more communication devices;
receiving media capabilities information of each communication device from the one or more communication devices based on the SDP, wherein the media capabilities information includes at least one of an information associated with a type of media that each communication device is capable of receiving and information about a type of media that each communication device is incapable of receiving; and
establishing a communication session between the first communication device and each of the one or more communication devices based on the type of media that each communication device is capable of receiving, wherein the type of media is identified from the media capabilities information.

17. The method of claim 16, wherein receiving media capabilities information comprises obtaining a sliced identifier for a type of media that a communication device is incapable of receiving, wherein the sliced identifier is received with information based on the SDP.

18. The method of claim 17, further comprising blocking media data associated with the sliced identifier.

19. The method of claim 17, further comprising forwarding media data associated with the sliced identifier to a third communication device.

20. The method of claim 16, wherein establishing the communication session between the first communication device and each of the one or more communication devices comprises:
blocking a type of media during communication between the first communication device and a second communication device from the one or more communication devices when the second communication device is unable to receive the type of media; and
establishing the communication session based on the media capabilities of the second communication device, wherein the media capabilities of the second communication device includes information about the type of media data that the second communication device is capable of receiving.

21. The method of claim 16, further comprising forwarding a type of media data to a third communication device based on a response received from the one or more communication devices and the media capabilities of each of the one or more communication devices.

22. A method for managing communication session establishment, the method comprising:
receiving a request to establish a communication session;
receiving one or more media type parameters along with the request, wherein the one or more media type parameters includes information about a type of media required to establish communication;
identifying media capabilities of a communication device managing the communication session establishment;
sending an indication to block one or more types of media data during communication; and
establishing the communication session based on the indication to block the one or more types of media data parameters.

23. The method of claim 22, wherein sending the indication comprises sending a response including information about the type of media data that is blocked along with a sliced identifier.

24. The method of claim 22, further comprising sending an indication to store one or more types of media data in a second communication device and maintaining the communication session between the communication device and the second communication device using the one or more types of data based on the media capabilities.

25. A server comprising:
a transceiver to:
receive a request from a first communication device to establish a communication session with one or more communication devices;
receive a plurality of media type parameters associated with communication session establishment based on a Session Description Protocol (SDP);
sending the plurality of media type parameters associated with the established communication session to the one or more communication devices; and
receive media capabilities information from each communication device from the one or more communication devices based on the SDP, wherein the media capabilities information includes at least one of an information about types of media that each communication device is able to receive and information about types of media that each communication device is unable to receive; and
a processor to:
establish the communication session between the first communication device and each of the one or more communication devices based on the media capabilities information received from each of the one or more communication devices.

26. The communication device of claim 25, wherein receiving the media capabilities information comprises obtaining a sliced identifier for a type of media that a communication device is incapable of receiving, and wherein the sliced identifier is received with information based on the SDP.

27. The communication device of claim 25, wherein the processor blocks a type of media during communication between the communication device and an other communication device when the other communication device is unable to receive the type of media; and establishes the communication session based on media capabilities of the other communication device, wherein the media capabilities of the other communication device includes information about the type of media data that the other communication device is capable of receiving.

28. A communication device comprising:
a transceiver to:
receive a request to establish a communication session;
receive one or more media type parameters along with the request, wherein the one or more media type parameters includes information about a type of media required for communication; and
send an indication to block one or more type of media data during communication; and
a processor to:
identify media capabilities of the communication device; and
establish the communication session based on the indication and the received one or more media type parameters.

29. The communication device of claim 28, wherein the transceiver sends a response including information about a type of media data that is blocked along with a sliced identifier.

30. The communication device of claim 28, wherein the transceiver sends the indication to store one or more types of media data in an other communication device and maintains the communication session between the communication device and the other communication device using the one or more types of data based on the media capabilities.
